(19) United States
(12) Patent Application Publication
(10) Pub. No.: US 2009/0319737 A1
(43) Pub. Date: Dec. 24, 2009

(54) METHOD FOR EXECUTING APPLICATIONS FROM A PORTABLE STORAGE DEVICE

(75) Inventors: Sunder Mani, Mandarin Garden (SG); Subodh Kumar, Glen Allen, VA (US)

Correspondence Address: KNOBBE MARTENS OLSON & BEAR LLP, 2040 MAIN STREET, FOURTEENTH FLOOR, IRVINE, CA, 92614, US

(73) Assignee: I-FLAPP TECHNOLOGIES PTE LTD, Singapore (SG)

(21) Appl. No.: 12/440,918

(22) PCT Filed: Sep. 10, 2007
(86) PCT No.: PCT/SG07/00305

§ 371 Date: Mar. 11, 2009

(30) Foreign Application Priority Data
Sep. 12, 2006 (SG) 200606306-9

(51) Int. Cl. G06F 12/16; G06F 12/00

(52) U.S. Cl. 711/162; 711/115; 711/E12.103; 711/E12.001

(57) ABSTRACT

A system (10) for executing an application (30) on a computer (40) where the application (30) is stored on a portable re-writable storage device (15), the system (10) comprising: a configuration file (25) in a backup location (24) on the device (15), the configuration file (25) containing information to enable an application (30) stored on the device (15) to be executed by the computer (40), an application manager (20) to compare stored configuration files (25) on the device (15) to identify a corresponding configuration file (25) for the application (30) stored on the device (15) to be executed by the computer (40), and to read the corresponding configuration file (25) to cause the computer (40) to recognise that the application (30) was installed on the computer (40) to permit the application (30) to be executed by the computer (40).

### TECHNICAL FIELD

The invention concerns a method for executing an application on a computer where the application is stored on a portable re-writable storage device.

### BACKGROUND OF THE INVENTION

Portable storage devices such as USB flash drives, SD devices and portable hard disk drives are typical devices for storing data to facilitate portability and allow rewrite on the device. However, these devices are merely data carriers which do not have a computer processor to independently execute programs on a new computer or a computer which does not have the appropriate software installed. This causes a problem for people who would like to carry their data on these portable storage devices but cannot use such data if a computer does not have a software program that can read, open or execute a data file or document stored on the device. Even if a computer program is carried on the portable storage device along with the data or the document, a new computer may be unable to execute the software program carried on the portable storage device because the operating system of the new computer will not consider the software program to be installed.

It is therefore desirable to provide a method and system for software programs that are stored on a portable storage device to be executable by any computer to enable data files stored on the portable storage device to be read and opened, by any computer.

### SUMMARY OF THE INVENTION

In a first preferred aspect, there is provided a method for executing an application on a computer where the application is stored on a portable re-writable storage device, the method comprising:
storing a configuration file in a backup location on the device, the configuration file containing information to enable an application stored on the device to be executed by the computer,
comparing stored configuration files on the device to identify a corresponding configuration file for the application stored on the device to be executed by the computer,
reading the corresponding configuration file to cause the computer to recognise that the application was installed on the computer to permit the application to be executed by the computer.

The step of reading the corresponding configuration file may comprise the step of updating registry keys on the computer using the information stored in the configuration file.

The application may be installed on the device by an installer package in the form of an MSI file.

The method may further comprise the steps of:
closing the application;
renaming the name of the backup location on the device to another name;
removing the updated registry keys from the computer; and
renaming the another name to the name of the backup location.

The portable storage device may be a flash drive, portable hard disk drive, SD card, or Memory Stick.

In a second aspect, there is provided a system for executing an application on a computer where the application is stored on a portable re-writable storage device, the system comprising:
a configuration file in a backup location on the device, the configuration file containing information to enable an application stored on the device to be executed by the computer,
an application manager to compare stored configuration files on the device to identify a corresponding configuration file for the application stored on the device to be executed by the computer, and to read the corresponding configuration file to cause the computer to recognise that the application was installed on the computer to permit the application to be executed by the computer.

In a third aspect, there is provided an application manager for executing an application on a computer where the application is stored on a portable re-writable storage device, the application manager comprising:
an installation module to store a configuration file in a backup location on the device, the configuration file containing information to enable an application stored on the device to be executed by the computer,
a program execution module to compare stored configuration files on the device to identify a corresponding configuration file for the application stored on the device to be executed by the computer, and to read the corresponding configuration file to cause the computer to recognise that the application was installed on the computer to permit the application to be executed by the computer.

The program execution module may update registry keys on the computer using the information stored in the configuration file.

The application manager may further comprise a program closing module to close the application, rename the name of the backup location on the device to another name, remove the updated registry keys from the computer; and rename the another name to the name of the backup location.

### BRIEF DESCRIPTION OF THE DRAWINGS

An example of the invention will now be described with reference to the accompanying drawings, in which:

FIG. 1 is a block diagram of a system in accordance with a preferred embodiment of the present invention; and

FIG. 2 is a process flow diagram of a method of operating the system of FIG. 1 in accordance with a preferred embodiment of the present invention.

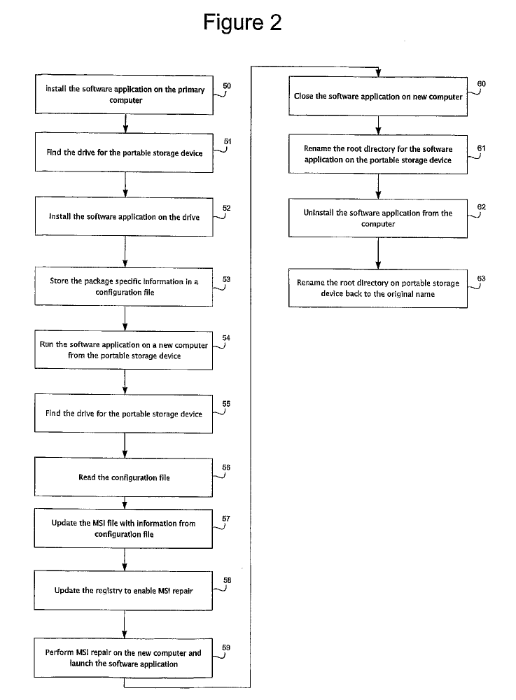

### DETAILED DESCRIPTION OF THE DRAWINGS

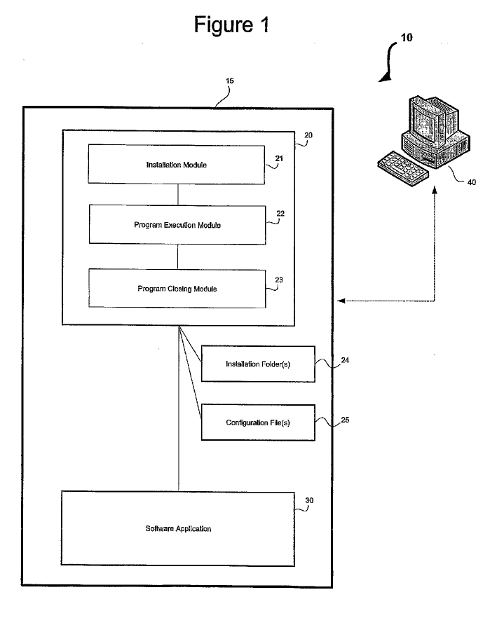

FIG. 1 and the following discussion are intended to provide a brief, general description of a suitable computing environment in which the present invention may be implemented. Although not required, the invention will be described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring to FIG. 1, a system 10 is provided for executing applications 30 from a portable storage device 15. The system 10 generally comprises a computer 40 to which the portable storage device 15 is connected to (mechanically and electrically or wirelessly), and an application manager 20 that resides on the portable storage device 15. A removable drive is formatted on the portable storage device 15. In a Windows-based environment, the removable drive is either in the NTFS or FAT file system format.

The application manager 20 provides functionality for the user to install and run software applications 30 directly and automatically from the removable drive and manage data that is stored on the removable drive. A user may execute software applications 30 from the removable drive and view the data directly from removable drive without requiring the software application 30 to be installed on or copied to the computer 40. The application manager 20 reinitializes the complete temporary data that has been created during the user session when the removable drive is disconnected or removed from the computer 40. The application manager 20 generally comprises three modules: Installation Module 21, Program Execution Module 22 and Program Closing Module 23.

Preferably, the application manager 20 is pre-installed on the portable storage device 15 and is used to manage the data and software applications 30 stored on the removable drive. Therefore, the execution of the software application 30 is independent of a computer 40 to facilitate mobile computing and permit execution of software programs stored on the portable storage device 15 regardless of whether the software program is installed on a computer 40. The application manager 20 saves the user time by not having to wait for a software application 30 to install on a computer 40, even if permission is allowed to install the software application 30 on the computer.

### Installation Module

The Installation Module 21 creates a back up copy of the software application 30 into an installation folder 24 on the removable drive by creating a folder 24 with a name designated by the user. The information required for running a repair on new computers 40, include: package name, package code, package license, etc are discovered and stored in a configuration file 25. The configuration file 25 does not necessarily have to be stored in the installation folder 24. A correct MSI package is found using published information of the software application 30 in a computer's registry and its own setup.ini file 25 from a computer's installation directory. For example, Microsoft Office has the following registry key for where the MSI package name is found,

\\HKEY_LOCAL_MACHINE\SOFTWARE\Classes\Installer\Products\90408209000 63D11C8EF00054038389C\SourceList. The value PackageName contains the corresponding MSI package of the installation. Multiple setup.ini files 25 can exist in installation folders 24, but the correct setup.ini file 25 is selected by comparing its entries of package code and package name.

### Program Execution Module

The Program Execution Module 22 executes the software application 30 on a new computer/target computer 40 which has no previous installation of the software application 30. The Program Execution Module 22 then launches the software application 30 for the user to work with. The term “new computer” means either a new computer or a computer where the software application 30 attempted to be executed, opened or for use with data stored on the portable storage device 15 has not been installed on. The Program Execution Module 22 uses an MSI repair mechanism to make the new computer 40 recognise and believe that the installation has already been performed for the new computer 40. Thus, the software application 30 that was installed on the removable drive is pointed to by the portable storage device 15. The following steps are implemented when the application is executed on new computer 40 for the first time:
1. When a user executes any software application 30 stored on the removable drive, the information necessary to start the software application 30 is read from the configuration file 25.
2. The corresponding MSI package that is found is edited for properties like install location 24, license key, etc.
3. The software application 30 is repaired on the new computer 40 on first use either by launching the software application 30 directly or by opening a file that corresponds to the application's data document types.

### Program Closing Module

The Program Closing Module 23 reverses the changes made by the Program Execution Module 22 that has performed the MSI repair. If a MSI repair was performed to run the software application 30, the directory containing the software application 30 on the portable storage device 15 is renamed, the software application 30 is uninstalled from the new computer 40, and the directory containing the software application 30 on the portable storage device 15 is renamed back to the original name of the directory. After terminating the use of the software application 30, the new computer 40 reverts to its original configuration and the setup it was before the user started using the software application 30 on the portable storage device 15.

In a typical scenario, a user may install 50 the software application 30 on a primary computer initially. This is optional, as the user may avoid doing so and install it directly onto the portable storage device 15. The portable storage device 15 is connected to the primary computer and the removable drive for the portable storage device 15 is detected 51. The software application 30 is installed onto the portable storage device 15. During installation, the package specific information is stored in a configuration file 25 on the portable storage device 15. Next, the user carries the portable storage device 15 to a new computer 40, and attempts to execute 54 the software application 30 on the portable storage device 15. When the user connects the portable storage device 15 to the new computer 40, the removable drive for the portable storage device 15 is detected 55. The application manager 20 detects the launch of the software application 30 and locates and reads 56 the configuration file 25 associated with the software application 30. The MSI file is updated 57 with information from the configuration file 25. The registry of the new computer 40 is updated 58 to enable an MSI repair. The MSI repair is performed on the new computer 40 and the software application 30 is launched 59. Next, the user finishes working with the software application 30 and decides to close 60 it. The application manager 20 detects the closing of the software application 30 and renames 61 the root directory for the software application 30 on the portable storage device 15. The software application 30 is uninstalled 62 from the new computer 40 by removing the update of the registry that was made. The root directory is renamed 63 on the portable storage device 15 is renamed back to its original name.

Although a flash drive has been described, it is envisaged that other portable storage devices 15 are suitable such as portable hard disk drive, SD card, or Memory Stick.

Although the application manager 20 has been described as software, it may be embodied as firmware or hardwired into a hardware component.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for executing an application on a computer where the application is stored on a portable re-writable storage device and executing the application directly and automatically from the portable re-writable storage device without requiring the application to be installed on or copied to the computer, the method comprising:
storing a configuration file in a backup location on the device, the configuration file containing application specific information to enable an application stored on the device to be executed by the computer,
locating and comparing stored configuration files on the device upon detecting launch of the application to identify a corresponding configuration file for the application stored on the device to be executed by the computer,
reading the corresponding configuration file to configure and edit properties of the computer to cause the computer to recognise by updating registry keys on the computer that the application was installed on the computer to permit the application to be executed on the device by the computer, using the application specific Information stored in the corresponding configuration file to update the registry keys on the computer and enable the computer to launch the application on the device.

2. The method according to claim 1, wherein the step of reading the corresponding configuration file comprises the step of updating registry keys on the computer using the information stored in the configuration file of MSI based format with MSI repair.

3. The method according to claim 1, wherein the application is installed on the device by an installer package in the form of an MSI file.

4. The method according to claim 2, further comprising the steps of:
closing the application;
renaming the name of the backup location on the device to another name;
removing the updated registry keys from the computer using MSI Uninstall; and
renaming the another name to the name of the backup location.

5. The method according to claim 1, wherein the portable storage device is a flash drive, portable hard disk drive, SD card, or Memory Stick.

6. A system for executing an application on a computer where the application is stored on a portable re-writable storage device and executing the application directly and automatically from the portable re-writable storage device without requiring the application to be installed on or copied to the computer, the system comprising:
a configuration file in a backup location on the device, the configuration file containing application specific information to enable an application stored on the device to be executed by the computer,
an application manager to locate and compare stored configuration files on the device upon detecting launch of the application to identify a corresponding configuration file for the application stored on the device to be executed by the computer, and to read the corresponding configuration file to configure and edit properties of the computer to cause the computer to recognise by updating registry keys on the computer that the application was installed on the computer to permit the application to be executed on the device by the computer, using the application specific information stored in the corresponding configuration file to update the registry keys on the computer and enable the computer to launch the application on the device.

7. An application manager for executing an application on a computer where the application is stored on a portable re-writable storage device and executing the application directly and automatically from the portable re-writable storage device without requiring the application to be installed on or copied to the computer, the application manager comprising:
an installation module to capture a configuration file of MSI setup application, store the configuration file in a backup location on the device, the configuration file containing application specific information to enable an application stored on the device to be executed by the computer,
a program execution module to locate and compare stored configuration files on the device upon detecting launch of the application to identify a corresponding configuration file for the application stored on the device to be executed by the computer, and to read the corresponding configuration file to configure and edit properties of the computer to cause the computer to recognise by updating registry keys on the computer that the application was installed on the computer to permit the application to be executed on the device by the computer, using the application specific information stored in the corresponding configuration file to update the registry keys on the computer and enable the computer to launch the application on the device.

8. The application manager according to claim 7, wherein the program execution module updating registry keys on the computer using the information stored in the configuration file of MSI based format with MSI repair.

9. The application manager according to claim 7, further comprising a program closing module to close the application, rename the name of the backup location on the device to another name, remove the updated registry keys from the computer, and rename the another name to the name of the backup location.
